(19) United States
(12) Patent Application Publication
(10) Pub. No.: US 2003/0014208 A1
(43) Pub. Date: Jan. 16, 2003

(54) Apparatus and method for testing computer equipment for use in networks

(76) Inventors: Howard Glynn, Edinburgh (GB); Spencer K. Hunter, Hayward, CA (US)

Correspondence Address: Robert C. Kowert, Conley, Rose, & Tayon, P.C., P.O. Box 398, Austin, TX, 78767, US

(21) Appl. No.: 09/905,669

(22) Filed: Jul. 13, 2001

(51) Int. Cl. G06F 19/00

(52) U.S. Cl. 702/120

(57) ABSTRACT

Apparatus for testing computer equipment comprises a plurality of test locations for the equipment (8). Each test location is coupled to one of a plurality of test controllers (12) which are in turn coupled to a test administration server (2). This includes apparatus for monitoring the status of tests run by the test controllers coupled to the test administration server. The test administration server can load up test software and delegate this to the test controllers which then run sequences of tests on the computer equipment. These tests are monitored by the test administration server. The sequence of tests run can be modified in dependence on the monitored results.

### BACKGROUND OF THE INVENTION

1. Field of the Invention

This invention relates to an apparatus and method for testing computer equipment and in particular computer equipment of the type used in storage area networks and which requires high levels of reliability.

2. Background of the Invention

In many network applications and particularly with networked storage devices a high degree of reliability is required for equipment in the network, and in particular for any equipment without which the network cannot operate. This is a requirement of Local Area Networks (LAN), Wide Area Networks (WAN) and Internet equipment. Accordingly, manufacturers have to perform extensive testing on all equipment before it leaves the factory to ensure that it is reliable.

Testing of this type typically requires several hours and can take several days to several weeks depending on the exact equipment and customer requirements. Systems for these are set up to run a large number of predefined tests on the equipment to test all its capabilities and to determine whether or not it fails in any areas. These tests can be modified according to specific type and makeup of products. In the case of e.g. network storage devices which might comprise, for example, a box of 18, 73 gigabyte hard drives the tests include making access to data on discs at maximum rate for a significant period of time. In most cases, there are at least several hundred tests to be run on a network storage device.

The test hardware for running such tests have traditionally been large and monolithic, difficult to brought to different environments, and requiring a high level of specialised knowledge. The test systems comprise typically an array of racks for the devices under test, each slot in the racks having a controller which is configured with software to run the tests required on the device under test. In order to change the test routines, each controller has to be loaded with new software.

As many manufacturers outsource production nowadays it is important that parties to whom production is outsourced are able to set up test equipment and procedures quickly and easily for different types of equipment. This has been not possible with existing systems.

### SUMMARY OF THE INVENTION

An embodiment of the invention provides an apparatus for testing computer equipment which has a plurality of test locations for the equipment, a plurality of test controllers each coupled to at least one test location for controlling the tests to be run on the equipment, and a test administration server coupled to all the test controllers, the test administration server including apparatus for setting up test software in each of the test controllers, and at least one graphical user interface coupled to the test administration server for monitoring progress of testing of equipment.

In a further embodiment the graphical user interface is controlled to display a listing of the test sequence currently in use, and a visual indication as to whether or not each test has passed or failed on each of the controllers.

In a further embodiment, the visual indication is a colour indication.

In another embodiment of the invention there is provided a method for configuring a testing apparatus for computer equipment comprising the steps of, providing test locations for the equipment, coupling each test location to a test controller, coupling each controller to a test administration server, loading test software into the test administration server, and subsequently loading the test software into each test controller from the test administration server.

Specific embodiments of the invention will now be described in detail by way of example with reference to the accompanying drawings in which:

### BRIEF DESCRIPTION OF THE DRAWINGS

FIG. 1 is a block diagram of a test system embodying the present invention;

FIG. 2 shows schematically the functionality of the test administration server in FIG. 1; and

FIG. 3 shows a flow diagram for testing of equipment in an embodiment of the invention.

### DETAILED DESCRIPTION OF PREFERRED EMBODIMENTS

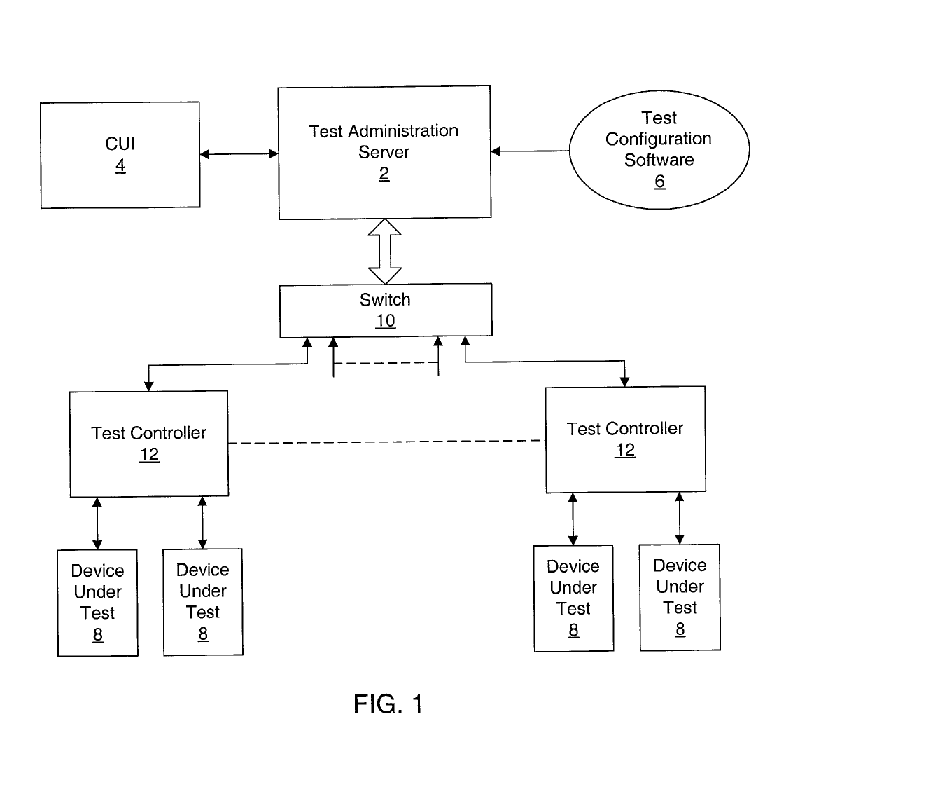

FIG. 1 shows a block diagram of a test arrangement. A test administration server (TAS) 2 is coupled to a graphical user interface 4 which a user uses when controlling the TAS 2. The TAS 2 is a monitoring station and file server for a plurality of test controllers 12. It delegates to each of these controllers 12 a test engine which is a sequencing program that can run any number of commands (tests) on a system in a predetermined order. The TAS 2 is loaded with test configuration software 6 to run a predetermined set of tests on a plurality of devices under test 8 (DUT). This is stored in files on the TAS 2 and subsequently delegated to the test controllers 12. A switch 10 couples the TAS 2 to the plurality of test controllers 12. Each of these runs the tests determined by the test configuration software 6 on any device under test which has been coupled to it. In this particular example, two devices under test 8 are shown coupled to each test controller. The test controllers can be configured to have only one port to couple to a device 8 or can be configured to have more than one port. Typically, the switch will have 32 ports for coupling to test controllers 12. Thus, with 32 test controllers which can each run tests on two devices 8 a maximum of 64 devices 8 can be tested at any one time.

The test controllers 12 are typically relatively small control devices. The test administration server is a larger device but there is only one TAS 2.

The devices under test 8 are mounted in racks which incorporate links to the relevant test controller 12. Typically one test controller will control each rack and will be coupled to the device under test 8 by optic fibres or by SCSI cables. Each rack may receive more than one device 8.

The tests run on device 8 are product specific tests. Therefore, each product requires different test configuration software to be loaded in the test controllers 12 via the TAS 2. The test software is typically provided on one or more CD-ROMs or other computer media which is read by and loaded into the file system of the TAS 2. This software also includes all necessary interface software for a user to set up and control the test software using a keyboard and the GUI 4.

Once the test configuration software 6 has been loaded in the TAS 2 a user can commence loading of the relevant portions of the software into the test controllers 12. This may be done one at a time via the switch 10 which is also controlled by the TAS 2, or can be done simultaneously in a plurality of controllers, according to the bandwidth of the system. Therefore, e.g. 16 controllers can be configured in about 45 minutes.

Using such a set up technique is considerably quicker than traditional systems where it was necessary to load the software into each test controller 12 in turn. Instead, what happens here it that a TAS 2 is loaded with the test and configuration software 6 in e.g. 60 seconds by copying from a CD-ROM. It stores this in its file system The TAS 2 can be set up such that when test configuration software 6 is loaded to it, it automatically starts to set up test software in the test controllers 12. This typically enables the whole system to by set up in about 2.5 hours from unboxing to first units on test.

Preferably the TAS 2 is provided with Internet connectivity such that it can be logged onto and monitored remotely. This type of facility is particularly important to large companies where design of products and the writing of test and configuration software takes place in one location whilst the manufacture takes place in another. It enables a location remote from the point of manufacture and test to monitor the testing procedure and make adjustments remotely as required. Thus, the support services for the testing are significantly enhanced.

In addition, it will be appreciated by those skilled in the art that the embodiment proposed makes a clear separation between product test and configuration and the test system. It provides a flexible test system which can be configured to test a wide variety of different computer devices by loading the TAS 2 with the particular product test software which can then be loaded to the various test controllers 12 in a short period of time.

The Internet connectivity of the system makes support for the system much easier from remote sites. The data capturer can then drive quality and test time metric improvements rather than exacerbating problems.

Remote monitoring of the testing enables the person doing the monitoring to connect to different test systems at different locations and switch between these. These need not all be systems testing the same equipment.

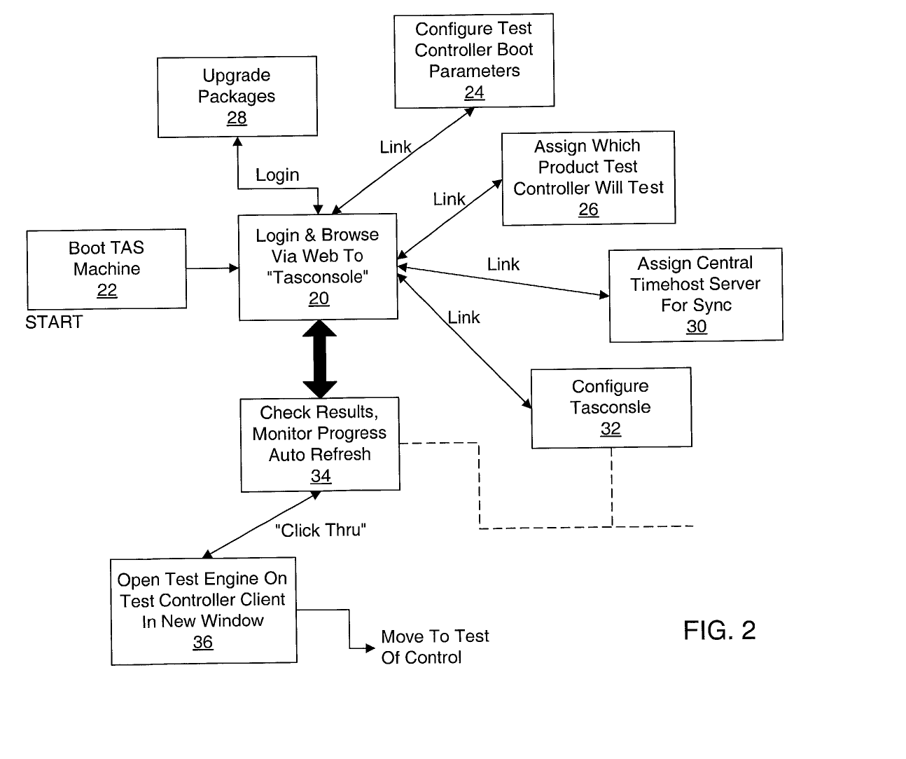

FIG. 2 shows a schematic diagram of the operation of the TAS 2. At 20, a user performs a login via the Internet to the particular TAS at its “TAS console”. It is then able to browse the operations controlled by that TAS 2. A visual display is provided to enable it to perform efficient monitoring. A number of operations can be formed from this login session and these include the following:

to form an initial system boot of the test controllers 12 which is shown at 22;

configure the test controllers 12 boot parameters as they are started by the TAS 2 at step 24;

assign a product to be tested by each test controller at 26;

input upgrade packages to test software as required at 28; and

assign a central time host server for synchronisation with the factors system clocks to ensure data integrity and parent abnormalities;

performing configuration of the TAS console at 32 to enable any number of TAS consoles to be monitored from a single screen; and,

log in session, check results, monitor progress, etc. for the tests being run by each test controller 12 at 34.

This session is connected to the test controllers 12 and enables a test engine or test sequence to be opened at a particular controller 36.

For clarity, this is the timeline for setting up a test area.

1. Unbox and prepare all equipment.

2. TAS Computer is installed with the operating system (OS)—takes 30 to 45 minutes.

3. A portion of the TAS disk contains a duplicate image of that OS. This is the 30-45 minutes mentioned above that is done one time with one command when machine is first commissioned.

4. Customization software is run to load an additional package pertinent to manufacturing, this can take about 30 minutes to run, interactively as well via an installation program.

5. A (small) portion of the TAS disk contains test configuration information. This is not upgraded in less than 60 seconds on a regular (say weekly, fortnightly) basis. This not automatically propagated to the test controllers unless requested (i.e it should not impact anything currently on test). At this point work on the TAS us completed, but the test controllers are still effectively blank machines.

6. When a test controller is requested to be built, it uses the duplicate image of the OS on the TAS, as if it were being installed from CD, to generate the test controller environment automatically. When it has done that, it installs the test configuration info, and the machine is ready to test attached boxes. This can be done over and over again as many times as the user wishes. This takes about 30 minutes per machine, or up to 45 minutes if many controllers are built concurrently.

7. Total time from unboxing to first tests starting is around 2.5 hours.

8. Summary:

1. Install OS on TAS (one time only)

2. Install duplicate image on TAS to build controllers (one time only).

3. Install customisation software and additional packages (one time only).

4. Install test configuration scripts and files (regularly).

5. Request to build test controller(s) (regularly).

6. Run tests on test controllers (constantly)

Generally, the user will log into the TAS machine at 20 and having identified one of the 32 test controllers 12 to be used will then open a connection to that machine and execute a single command to instruct the machine to build itself as a test controller, using software already loaded onto the TAS. This process only needs to be done once for that test controller until it is required to test a different piece of equipment in which case a new software package 6 must be loaded into the TAS 2 and then set up in a test controller 12. Once the test controller has been set up, a user can log in via a web browser and select the URL associated with the test controller being considered. The device under test is coupled to the test controller in one of the racks and information is input about serial number, type of unit, test stage, etc. This information can be read electronically from the factors shop floor system. Alternatively, the unit can carry one or more bar codes or other machine readable indicia which indicate the location of the unit and its serial number. This information can be directed via a shop floor control system to the TAS 2 and then to the user.

Either the user or a shop floor control system can indicate that the unit should start testing. When this happens, the user will see a screenshot of the tests to be run which he can browse through at any stage during the testing process. This screen will include at least a column describing each of the tests and a further column indicating the status of this test which will typically be passed, failed, or testing. Each of these states will be assigned a colour which will be seen by the user in the status box for each test, thereby making it easy for the user to pick out when e.g. a failure of the test has occurred.

If a particular test does fail then the user is given the option of re-running that test or resuming the overall test run at the next step.

Once completion of all the test steps has happened, the user is assigned an overall pass or a fail. The shop floor control systems can clear any units left to see if they are finished and can check the test results. If the unit has passed the test it can be disconnected and put ready for shipping. The barcode or the serial number will be scanned again and the shop floor control systems then make all necessary updates to their transaction logs.

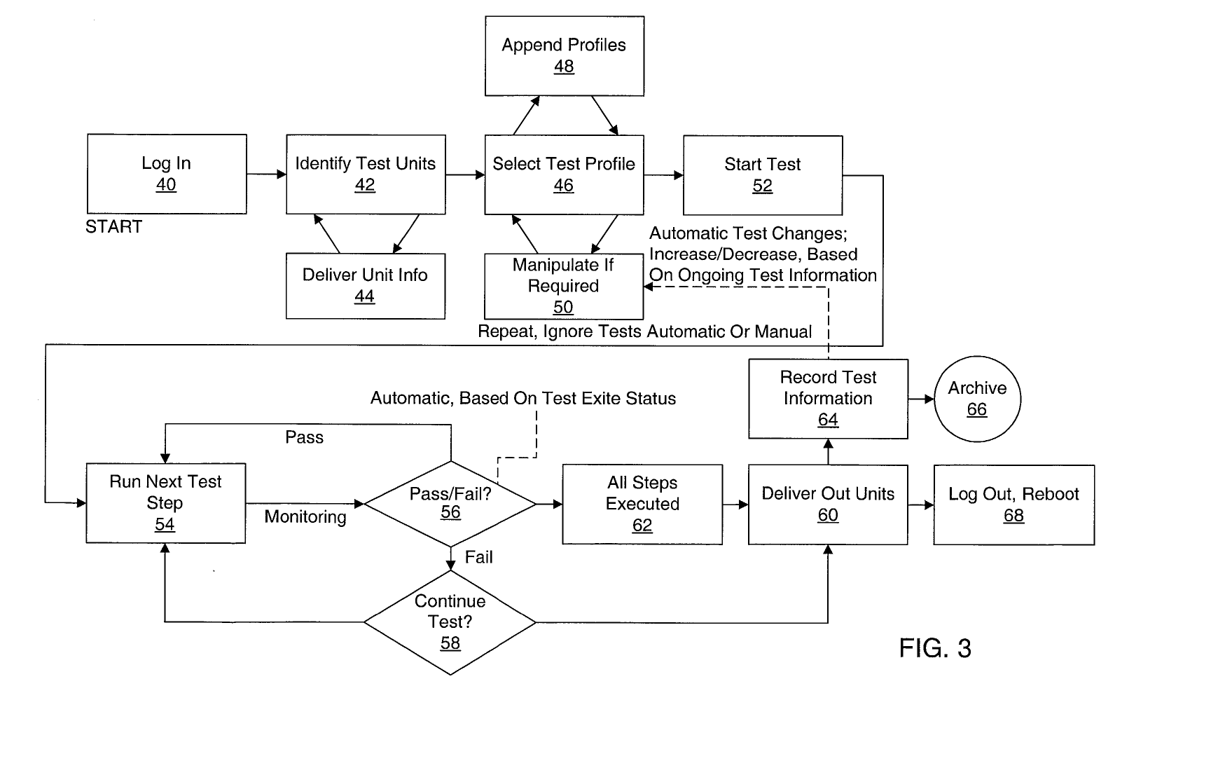

FIG. 3 shows the flow of control in a test procedure. Initially, there is a login to the test at 40 which assumes that the test controller 12 under consideration is powered up and has one or more devices 8 detached to it.

The devices are then identified at 42 by a deliver unit information step 44 this can be manual input or automatic delivery from the factors shop floor system.

A test profile is then selected at 46. The user is able to append additional tests to this at 48 or adjust the order of tests. Furthermore, the test profile can be manipulated automatically at 50. This can be in response to previous test results and will be discussed later.

Once the test profile has been selected, the test is started at 52. At 54, the next step in the test is run and a determination made as to whether or not it has passed or failed at 56. If it has passed then control returns to 54 and the next test step is run. If there is a fail indicated at test 56 then the user is prompted to decide whether or not to continue the test. This could be yes but record a fail in which case the control returns to step 54 or it could be no which would then pass control to the deliver out unit step 60.

The test can be set up to continue testing automatically even when there is a fail. Alternatively, it can be set up to continue testing automatically only if certain tests fail but not continue if other, possibly more important tests fail.

When all the steps are executed at 62 control passes to the deliver out unit step 60. At this, an indication is made on the shop floor that testing is completed for that particular unit. The test information is recorded at 64 and archived at 66. If the test information indicates that the unit has passed then it can be prepared for shipping to a customer. If the test has failed then the unit passes back to the shop floor with details of the tests failed and the parts of it which are faulty so that these may be corrected and the unit subsequently retested.

The test information is fed back to the test manipulation step 50. By monitoring the performance of all the tests and, in particular, the tests which fail most frequently the test profile can be altered so the tests which are most likely to result in a fail occur mean the start of the test profile whilst those least likely to result in a fail occur further into the test profile. It should be noted that the tests most likely to fail will change over time. This is because equipment is made up of a large number of components and preassembled packages supplied by other manufacturers. A batch of components which are slightly less well built than other batches from the same manufacturer may result in particular tests being failed. Therefore, the system can adapt to move these tests earlier in the test profile so that the faulty units are identified more quickly and the unit removed for remedial action before all the testing has been performed.

Another variation that can be made in the test profile is automatically to increase or decrease the duration of particular tests if they are found to relate to parts of the equipment which have a higher than average failure rate. Similarly, customer feedback from units which have failures once shipped can provide additional data to this test profile manipulation step 50.

When all tests have been performed and no further units are to be tested the user logs out or reboots the system at 68.

The above description relates to the testing of one device. Clearly, a plurality of devices will usually be tested at the same time and may be monitored from the TAS GUI by the user.

It will be appreciated that the above testing process described in relation to FIG. 3 is not product specific. The product specific part is the test profile which is provided by the test configuration software 6 of FIG. 1. The method provides a framework within which any piece of computer equipment requiring testing can be thoroughly tested in a manner which is adaptable. In particular, it is able to monitor the tests which are causing most problems so that these are scheduled to occur earlier in the test profile, thereby reducing testing times since units which fail will be taken out of the test sequence at an earlier time than they otherwise would be.

Although methods and systems consistent with the present invention have been described with reference to one or more embodiments thereof, those skilled in the art will know various changes in form and detail which may be made without departing from the present invention as defined the appended claims and therefore scope of equivalence.

1. Apparatus for testing computer equipment comprising:
a plurality of test locations for the equipment;
a plurality of test controllers, each coupled to at least one test location for controlling the tests to be run on the equipment;
a test administration server coupled to all the test controllers and configured to set up test software in each of the test controllers; and
apparatus for monitoring the status of tests run by the test controllers coupled to the test administration server.

2. Apparatus according to claim 1 including apparatus to monitor test results run by test controllers and to modify the sequence of tests run by the controllers in response thereto.

3. Apparatus according to claim 1 in which the apparatus for monitoring the status of tests comprises a graphical user interface which displays the status of each of the tests run by the test controllers.

4. Apparatus according to claim 3 in which each different status is indicated by a different colour on the graphical user interface.

5. Apparatus according to claim 1 in which the apparatus for monitoring comprises an Internet connection for remote monitoring.

6. A method for configuring a testing apparatus for computer equipment comprising the steps of:
providing test locations for the equipment;
coupling each test location to a test controller;
coupling each test controller to an administration server;
loading test sequencing software into the test administration server; and
loading the test sequencing software from the test administration server into each test controller.

7. A method for testing computer equipment comprising the steps of:
determining a sequence of tests for the equipment;
running the tests on a plurality of pieces of similar computer equipment;
monitoring the results of each test in the sequence for each piece of equipment; and
modifying the test sequence in dependence on the monitored results.

8. A method according to claim 7 in which the modifying steps includes moving tests which fail most frequently nearer to the start of the test sequence.

9. A method according to claim 7 in which the modifying step includes increasing the duration of tests which fail most frequently.

10. Apparatus for testing computer equipment comprising:
means for determining a sequence of tests for the equipment;
means for running the tests on a plurality of pieces of computer equipment;
means for monitoring the results of each test in the sequence for each piece of equipment; and
means for modifying the test sequence for each piece of equipment in dependence on the monitored results.

11. A computer program product comprising computer code which when executed on a computer for testing computer equipment causes it to operate according to the method of claim 6.

12. A computer program product comprising computer code which when executed on a computer for testing computer equipment causes it to operate according to the method of claim 7.
